(19) United States
(12) Patent Application Publication
(10) Pub. No.: US 2026/0072521 A1
(43) Pub. Date: Mar. 12, 2026

(54) DISPLAY IMAGE GENERATION DEVICE, CONTENT PROCESSING SYSTEM, AND DISPLAY IMAGE GENERATION METHOD

(71) Applicant: Sony Interactive Entertainment Inc., Tokyo (JP)

(72) Inventors: Mitsuru Nishibe, Chiba (JP); Daisuke Tsuru, Chiba (JP); Tatsuo Tsuchie, Tokyo (JP); Yuto Hayakawa, Tokyo (JP)

(73) Assignee: Sony Interactive Entertainment Inc., Tokyo (JP)

(21) Appl. No.: 19/303,069

(22) Filed: Aug. 18, 2025

(30) Foreign Application Priority Data
Sep. 9, 2024 (JP) 2024-155202

(51) Int. Cl. G06F 3/01; G06T 7/20; G06T 19/00; H04N 17/00

(52) U.S. Cl. CPC G06F 3/017; G06T 7/20; G06T 19/00; H04N 17/004; G06F 3/012; G06T 2207/10016; G06T 2207/30196

(57) ABSTRACT

Provided is a display image generation device including a state information acquisition section that acquires state information regarding a target in accordance with a figure of the target in an image obtained by video capturing by an imaging device, a state information control section that determines state information to be adopted, by switching whether or not to manipulate the state information in accordance with an elapsed time according to a situation, and a display image generation section that uses the determined state information to generate a display image that includes a virtual object reflecting motion of the target.

### CROSS REFERENCE TO RELATED APPLICATIONS

This application claims priority to Japanese Patent Application JP 2024-155202 filed Sep. 9, 2024, the entire contents of which are incorporated herein by reference for all purposes.

### BACKGROUND

The present disclosure relates to a display image generation device, a content processing system, and a display image generation method that generate a display image in which motion of a real object is reflected.

A technique for giving a sense of immersion into a virtual space by means of a head-mounted display, for example, has become commonplace in every field. For example, if a displayed virtual object is moved or a tactile sense is fed back in such a manner as to interact with user motion, the reality can be further enhanced in a virtual space. In content such as an electronic game, if user motion rather than an input device such as a controller is used as operation means, more intuitive operation can be performed.

### SUMMARY

To cause motion of a target such as a user to be reflected in an object in a display image in real time, it is necessary to perform a process of tracking the state of the target at high speed and with high accuracy. If, for example, a display frame rate is set to be high, high-quality images are qualitatively expected, but time allowed to perform the tracking process becomes short. This may cause deterioration in the accuracy of motion of the object or may make the object look unnatural. Thus, in a case where a target tracking process and a display image generating process are concurrently performed, ensuring the qualities of both of the processes is typically a major problem.

The present disclosure has been made in view of the above problems, and it is desirable to provide a technique of generating a high-quality display image that includes an object reflecting motion of a target.

According to an embodiment of the present disclosure, there is provided a display image generation device. The display image generation device includes a state information acquisition section that acquires state information regarding a target in accordance with a figure of the target in an image obtained by video capturing by an imaging device, a state information control section that determines state information to be adopted, by switching whether or not to manipulate the state information in accordance with an elapsed time according to a situation, and a display image generation section that uses the determined state information to generate a display image that includes a virtual object reflecting motion of the target.

According to another embodiment of the present disclosure, there is provided a content processing system. The content processing system includes the display image generation device described above, and a head-mounted display that acquires data regarding the display image from the display image generation device and displays the display image.

According to still another embodiment of the present disclosure, there is provided a display image generation method. The display image generation method includes acquiring state information regarding a target in accordance with a figure of the target in an image obtained by video capturing by an imaging device, determining state information to be adopted, by switching whether or not to manipulate the state information in accordance with an elapsed time according to a situation, and using the determined state information to generate a display image that includes a virtual object reflecting motion of the target.

According to yet another embodiment of the present disclosure, there is provided a computer program for a computer. The computer program includes, by a state information acquisition section, acquiring state information regarding a target in accordance with a figure of the target in an image obtained by video capturing by an imaging device, by a state information control section, determining state information to be adopted, by switching whether or not to manipulate the state information in accordance with an elapsed time according to a situation, and, by a display image generation section, using the determined state information to generate a display image that includes a virtual object reflecting motion of the target.

It is to be noted that a method, a device, a system, a computer program, or a recording medium having a computer program recorded therein, which is obtained by translating any combination of the above constituent elements or an expression in the present disclosure, is also effective as an embodiment of the present disclosure.

According to the present disclosure, a display image that includes an object reflecting motion of a target can be generated with high quality.

### BRIEF DESCRIPTION OF THE DRAWINGS

FIG. 1 is a diagram depicting an example of the appearance of a head-mounted display to which an embodiment can be applied;

FIG. 2 is a diagram depicting a configuration example of a content processing system to which the embodiment can be applied;

FIG. 3 is a diagram depicting an internal circuitry configuration of a content processing device according to the embodiment;

FIG. 4 is a block diagram depicting functional blocks of the content processing device according to the embodiment;

FIGS. 5A and 5B depict diagrams of examples of a display image generated by the content processing device according to the embodiment;

FIG. 6 is a diagram schematically depicting change in the display image in a case where a state information control section of the embodiment refrains from predicting state information;

FIG. 7 is a diagram for explaining an influence on a display image in a case where prediction of state information is not performed in the embodiment;

FIG. 8 is a diagram schematically depicting change in the display image in a case where the state information control section of the embodiment predicts state information;

FIG. 9 is a flowchart of process steps in accordance with which the content processing device of the embodiment generates and outputs a display image that includes a hand object reflecting motion of a user hand;

FIG. 10 is a diagram for explaining a manner in which an evaluation result of the accuracy of state information is used for content processing according to the embodiment; and

FIG. 11 is a diagram illustrating representative process timings with respect to change in the accuracy of state information in the embodiment.

### DETAILED DESCRIPTION OF THE PREFERRED EMBODIMENTS

The present embodiment relates to a technique of sequentially acquiring state information regarding a real object and causing the state information to be reflected in the state of an object in a display image in real time. In this regard, there are no limitations on means for acquiring the state information, means for displaying the image, the type of the real object, and the type of the object reflecting the state. As an example of the present embodiment, mainly explained is a manner in which the state of a user hand is acquired in accordance with an image captured by a camera installed in a head-mounted display and an image that includes a virtual hand object in the same state is displayed on the head-mounted display.

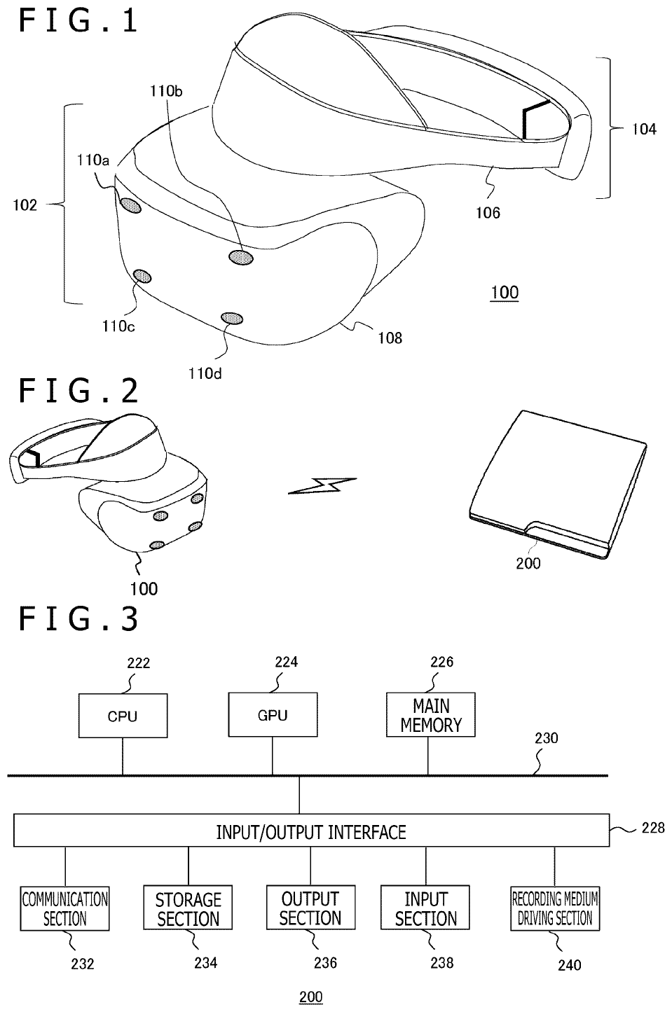

FIG. 1 is a diagram depicting an example of the appearance of a head-mounted display 100 to which the present embodiment can be applied. In this example, the head-mounted display 100 includes an output structure part 102 and a fitting structure part 104. The fitting structure part 104 includes a fitting band 106 that surrounds the head of a user when worn by the user such that the device is fixed. The output structure part 102 includes a casing 108 that is formed in such a manner as to cover left and right eyes when the user is wearing the head-mounted display 100. Inside the casing 108, a display panel that directly faces the eyes when the user is wearing the head-mounted display 100 is disposed.

Further, an ocular lens that is positioned between the display panel and the user's eyes when the user is wearing the head-mounted display 100 and that displays an enlarged image is disposed inside the casing 108. The head-mounted display 100 may further include a loudspeaker or an earphone at a position that corresponds to a user's ear when the user is wearing the head-mounted display 100. In addition, the head-mounted display 100 includes a motion sensor such as an acceleration sensor, a gyro sensor, or a geomagnetic sensor. The motion sensor may detect translation movement or rotational movement of the head of the user wearing the head-mounted display 100, that is, may detect the position and the posture at each clock time.

The head-mounted display 100 further includes cameras 110a, 110b, 110c, and 110d on the front surface of the casing 108 to perform video capturing of a real space surrounding the user. There are no particular limitations on the number and positions of the cameras 110a, 110b, 110c, and 110d. In the example depicted in the drawing, these cameras are disposed at four corners of the front surface of the casing 108. Hereinafter, the cameras 110a, 110b, 110c, and 110d may collectively be referred to as a camera 110. Video frames captured by the camera 110 are successively analyzed to track, in a three-dimensional space, motion of a user hand that is in the view field of the camera 110.

When a hand object simulating motion of a real hand is imaged according to the tracking result, virtual reality or augmented reality for allowing the user to pick up or move another virtual object can be implemented. Further, when a user hand makes a particular pose, corresponding information processing can be performed, and a result of the processing can be reflected in a display image. It is to be noted that, in addition to the user hand, another part of the user body, the whole body of the user, or a real object that is held or worn by the user, for example, may be set as the tracking target. In addition, a virtual object to be synchronized with the tracking target may vary depending on the tracking target. Hereinafter, pieces of information regarding the position, posture, shape, etc., of the target in the three-dimensional space which are acquired from each captured image frame are collectively referred to as “state information.”

It is to be noted that captured images taken by the camera 110 can be used to acquire the position and posture of the head-mounted display 100, that is, the position and posture of the user head, by visual simultaneous localization and mapping (V-SLAM). V-SLAM is a technique for acquiring the position and posture of a camera while creating an environment map by repeating a process of estimating a three-dimensional position of a real object from the positional relation among figures of the same real object in images captured from multiple viewpoints and a process of estimating the position and posture of the camera on the basis of the position of a figure of the real object in a captured image after the position of the real object is estimated.

The view field of an image to be displayed on the head-mounted display 100 is changed in such a manner as to correspond to the position and posture of the user head acquired by V-SLAM, whereby the user can obtain a sense of immersion into a display world. Further, when images captured by some of the cameras 110 are displayed in real time on the head-mounted display 100, a see-through mode for allowing the user to directly see the state of the real space in a direction to which the user is facing can be provided.

FIG. 2 depicts a configuration example of a content processing system to which the present embodiment can be applied. The head-mounted display 100 is connected to a content processing device 200 via wireless communication or via an interface such as universal serial bus (USB) type-C for establishing connection with peripheral devices. The content processing device 200 may be further connected to a server over a network. In such a case, the server may provide, to the content processing device 200, an on-line application such as a game that a plurality of users can participate in over the network.

The content processing device 200 basically processes a content program to generate display images and sound data, and transmits the images and the data to the head-mounted display 100. The head-mounted display 100 receives the display images and the sound data and outputs the images and the data as content images and content sounds. Here, the content processing device 200 sequentially acquires frame data of a video captured by the camera 110 of the head-mounted display 100, and obtains the state information regarding a user hand in real time in accordance with the acquired frame data.

The content processing device 200 generates a display image that includes a virtual hand object which moves in association with the user hand, on the basis of the acquired state information. In the present embodiment, acquisition of the state information at a rate lower than the generation rate of display images is allowed, whereby the accuracy of acquiring state information can be maintained irrespective of a frame rate. Accordingly, robustness of the accuracy of the object motion with respect to the surrounding environment including the brightness can be enhanced. The content processing device 200 may detect that the hand makes a particular hand pose (gesture), in accordance with the state information, and may regard the pose as a command input and perform the corresponding information processing, as explained above.

The content processing device 200 may further sequentially acquire information regarding the position and posture of the user head by the above-mentioned V-SLAM or another technique, and generate a display image in the corresponding view field. In this case, the content processing device 200 may acquire a measurement value obtained by a motion sensor included in the head-mounted display 100, and acquire the position and posture of the user head with higher accuracy. It is to be noted that a person skilled in the art will understand that there are variations of processes to be performed and display images to be generated in the content processing device 200 using the state information regarding a target such as a hand.

FIG. 3 is a diagram depicting an internal circuitry configuration of the content processing device 200. The content processing device 200 includes a central processing unit (CPU) 222, a graphics processing unit (GPU) 224, and a main memory 226. These sections are mutually connected via a bus 230. Further, an input/output interface 228 is connected to the bus 230. A communication section 232, a storage section 234, an output section 236, an input section 238, and a recording medium driving section 240 are connected to the input/output interface 228.

The communication section 232 includes a peripheral device interface such as a USB and an interface for networks such as a wired local area network (LAN) or a wireless LAN. The storage section 234 includes a hard disk drive, a nonvolatile memory, or the like. The output section 236 outputs data to the head-mounted display 100. The input section 238 receives a data input from the head-mounted display 100. The recording medium driving section 240 drives a removable recording medium which is a magnetic disk, an optical disk, a semiconductor memory, or the like.

The CPU 222 generally controls the content processing device 200 by executing an operating system stored in the storage section 234. In addition, the CPU 222 executes various kinds of programs that are read out from the storage section 234 or a removable storage medium and are loaded into the main memory 226 or that are downloaded via the communication section 232. The GPU 224 has a geometry engine function and a rendering processor function. The GPU 224 performs rendering according to a rendering command supplied from the CPU 222, and outputs a result of the rendering to the output section 236. The main memory 226 includes a random access memory (RAN) to store programs and data that are required for processing.

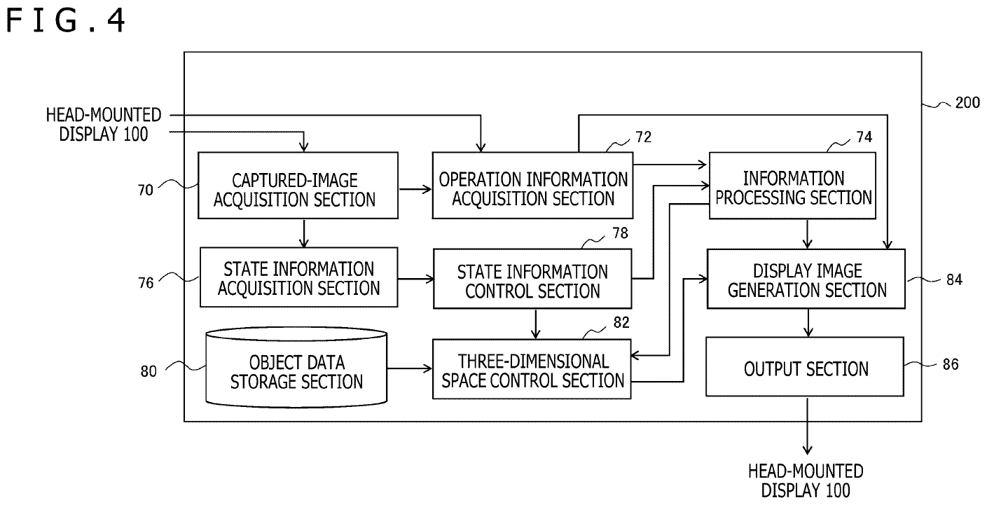

FIG. 4 is a block diagram depicting functional blocks of the content processing device 200. The content processing device 200 can execute ordinary information processing such as proceeding with an application and communicating with a server. However, FIG. 4 particularly depicts functional blocks concerning generation of display images based on hand state information. In this regard, the content processing device 200 can be realized as a display image generation device. At least some of the functions of the content processing device 200 depicted in FIG. 4 may be implemented in a server that is connected with the content processing device 200 over a network, or may be implemented in the head-mounted display 100.

In addition, the functional blocks depicted in FIG. 4 can be implemented by the circuits depicted in FIG. 3 in terms of hardware, and can be implemented by a computer program having the functions of the plurality of functional blocks in terms of software. Therefore, a person skilled in the art will understand that these functional blocks can be implemented in many different ways by hardware, by software, or a combination of the two, and the functional blocks are not limited to being implemented in a particular way.

The content processing device 200 includes a captured-image acquisition section 70 that acquires data regarding a captured image, an operation information acquisition section 72 that acquires information concerning user operation details, a state information acquisition section 76 that acquires state information regarding a hand from a captured image, a state information control section 78 that controls time change in the state information, an object data storage section 80 that stores data regarding an object to be displayed, and a three-dimensional space control section 82 that controls a three-dimensional space to be displayed. The content processing device 200 further includes an information processing section 74 that performs information processing in accordance with user operation details and state information regarding a hand, a display image generation section 84 that generates a display image, and an output section 86 that outputs data regarding the display image.

The captured-image acquisition section 70 sequentially acquires, at a predetermined rate, image frame data of a video captured by the camera 110 of the head-mounted display 100. The operation information acquisition section 72 acquires details of a user operation performed on the in-progress content by means of the head-mounted display 100 or an unillustrated controller, from the head-mounted display 100 or the controller. The operation information acquisition section 72 further acquires information regarding the position and posture of the head-mounted display 100, that is, the position and posture of the user head, by the above-mentioned V-SLAM or in accordance with various kinds of sensor data.

The state information acquisition section 76 acquires hand state information of each time step in accordance with captured images acquired by the captured-image acquisition section 70. By way of example, the state information acquisition section 76 estimates the hand state information by using a deep neural network (DNN). In this case, the state information acquisition section 76 internally holds DNN model data for estimating hand state information, which is acquired in advance by executing deep learning using a large number of images of hands as teacher data.

It is to be noted that a person skilled in the art will understand that there are variations in the type of a neural network or a learning algorithm to be constructed by the deep learning. However, means for the state information acquisition section 76 to acquire the state information is not limited to the DNN. By way of example, the state information acquisition section 76 may acquire the state information by fitting between a positional relation of hand feature points in a captured image and a three-dimensional hand model.

The state information control section 78 controls time change in the state information at each time step that corresponds to a frame rate of display images. Specifically, according to the speed of the hand or the accuracy of acquiring the state information, the state information control section 78 switches between directly adopting the state information acquired from a captured image and manipulating the state information in accordance with an elapsed time, to generate a display image.

For example, when the speed of the hand is less than a threshold, which indicates that the hand is considered to be at rest, the state information control section 78 directly adopts the state information acquired from the most recently captured image. When the speed of the hand is equal to or greater than the threshold, which indicates that the hand is considered to be moving, the state information control section 78 imparts a change that corresponds to an elapsed time from the time of capturing the image to the state information. Hereinafter, a process of imparting a change to the state information in accordance with an elapsed time is referred to as “prediction” of the state information.

As a result of this switching, the quality of a display image including a hand object can be stabilized even if state information is acquired at a frequency lower than a frame rate of display images. Further, the state information control section 78 may evaluate the state information acquisition accuracy under a predetermined condition, and may perform switching to predict state information when the estimation indicates that the accuracy at a certain level or higher is obtained and refrain from predicting state information when the estimation indicates that such an accuracy is not obtained. An explanation of specific processes in the state information control section 78 will be given later.

The three-dimensional space control section 82 controls a three-dimensional space of a display world including the hand object in accordance with the latest state information determined by the state information control section 78. Here, the three-dimensional space control section 82 causes the hand state determined at a time step corresponding to a frame rate of display images to be reflected in the state of the hand object. The object data storage section 80 stores a three-dimensional model of the object that exists in the display world.

The information processing section 74 performs information processing on content such as an electronic game in accordance with user operation details acquired by the operation information acquisition section 72 and the latest state information determined by the state information control section 78. By way of example, the information processing section 74 determines a command input of a hand gesture in accordance with the state information determined by the state information control section 78, and performs a process corresponding to the command input. Alternatively, the information processing section 74 may make a determination as to a collision between the hand object and another object in accordance with the state information and change the state of the other object if needed, to execute an interaction with the hand object. There are no particular limitations on other processes to be performed by the information processing section 74 and purposes thereof.

The information processing section 74 may request that the three-dimensional space control section 82 cause a result of the information processing to be reflected in the three-dimensional space of the display world. Accordingly, motion of the hand in the real world can be reflected in the hand object, and further, another object can also be changed in accordance with the progress of the content or an interaction with the hand object. The display image generation section 84 renders the state of the three-dimensional space of the display world at a predetermined frame rate. At this time, the display image generation section 84 may change the view field relative to the display world according to motion of the user head. The output section 86 sequentially outputs frame data of the generated display images to the head-mounted display 100.

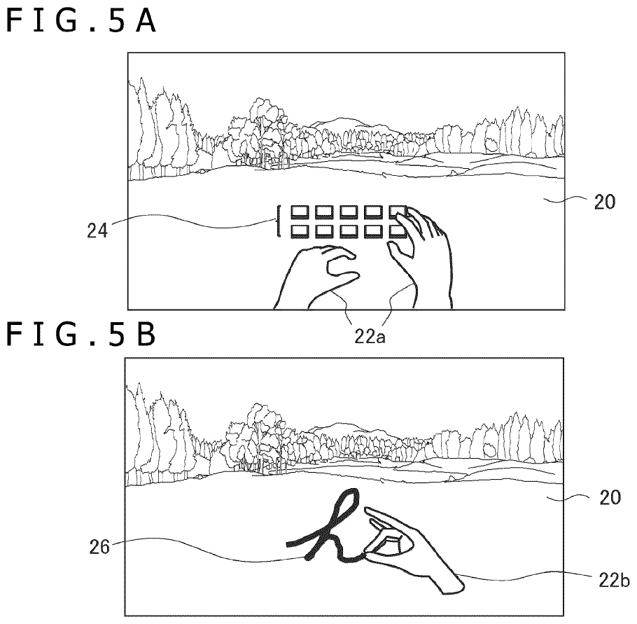

FIGS. 5A and 5B depict examples of a display image generated by the content processing device 200 according to the present embodiment. Display images of FIG. 5A and FIG. 5A are both based on an assumption that a user is in an outdoor virtual space 20, and hand objects 22a and 22b are depicted. The content processing device 200 acquires state information regarding a hand in a real world in accordance with captured images transmitted from the head-mounted display 100, and then sequentially causes the state information to be reflected in the state of the hand object 22a or 22b.

The display image of FIG. 5A represents a scene in which a keyboard 24 depicted in the virtual space 20 is being operated with the hand object 22a. When the user moves a user's hand as if depressing a desired key of the keyboard 24 while watching the display image, the hand object 22a moves in the same manner. Accordingly, a key operation is executed. In this case, the information processing section 74 identifies an operation target key by determining a collision between a fingertip and the keyboard 24 in the three-dimensional space in accordance with the hand state information.

In parallel with this, the three-dimensional space control section 82 sets, in the three-dimensional space, a three-dimensional model of the hand object 22a in a state corresponding to the state information, and the display image generation section 84 represents the three-dimensional model along with, for example, the keyboard 24 in the display image. The three-dimensional space control section 82 may change the position or color of the operation target key in the keyboard 24 in such a manner that the operation target key looks as if being depressed with the hand object 22a. As a result of repeating the above operations at a predetermined rate, motion of the hand object 22a and the keyboard 24 can be presented in association with the user hand.

The display image of FIG. 5B represents a scene in which a character 26 is being drawn with the hand object 22b in the virtual space 20. In this example, the information processing section 74 detects, as a character drawing mode, a gesture of touching a tip of a thumb by tips of middle and ring fingers while raising index and little fingers. In this mode, when the user moves the hand, the hand object 22b moves in association with this. Thus, a track of the fingertip of the middle finger or the like is represented as the character 26.

Here, the three-dimensional space control section 82 moves the hand object 22b in accordance with the state information, and makes a line object appear to represent a track of the tip. As a result, the character 26 displayed by the display image generation section 84 is defined as a line in three-dimensional. Accordingly, when the user wearing the head-mounted display 100 changes the viewpoint, the character 26 viewed obliquely or viewed from the rear side can also be expressed. It is to be noted that the depicted display images are merely examples. A person skilled in the art will understand that there are variations in the shape of the object reflecting the hand state information and variations in forms that can be realized by the object.

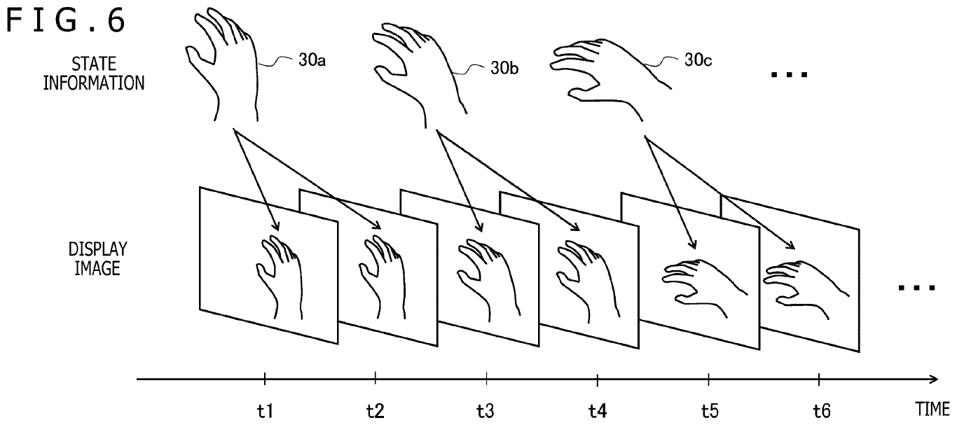

FIG. 6 schematically depicts change in the display image in a case where the state information control section 78 refrains from predicting the state information. In FIG. 6, the horizontal direction indicates a time axis, the upper part schematically indicates hand states 30a, 30b, 30c, . . . acquired from captured images at respective time steps, and the lower part schematically indicates a frame sequence of display images including a hand object. FIG. 6 is based on, as an example, an assumption that the state information acquisition section 76 acquires the state information from captured images with a frequency which is ½ of the frame rate of the display images. However, the frequency of acquiring the state information is not limited to this.

First, a display image at time t1 is generated in accordance with the state information (state 30a) acquired immediately before time t1 from a captured image. At next time t2, a display image is generated in accordance with the same state information (state 30a) because the state information based on the captured image is not updated. That is, at time t1 and time t2, the hand object whose position, posture, and shape in the three-dimensional space are the same is represented.

At next time t3, a display image is generated in accordance with the state information (state 30b) because the state information is updated. At next time t4, a display image is generated in accordance with the same state information (state 30b) because the state information based on the captured image is not updated. That is, at time t3 and time t4, the hand object whose position, posture, and shape in the three-dimensional space are the same is represented. Likewise, at next time t5 and time t6, the hand object whose position, posture, and shape in the three-dimensional space are the same is represented in the display image in accordance with the same state information (state 30c).

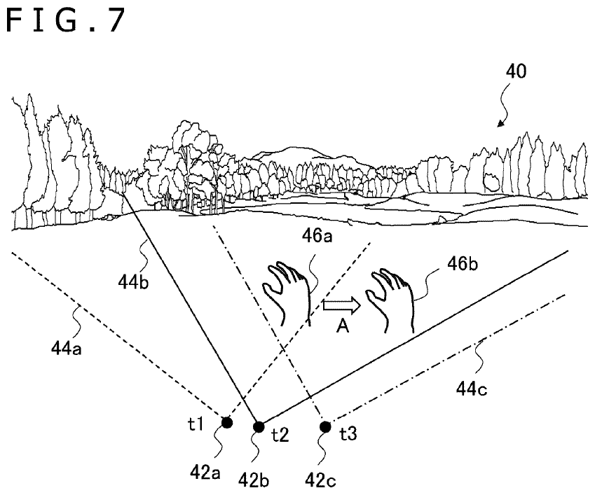

FIG. 7 is a diagram for explaining an influence on a display image in a case where prediction of state information is not performed. The drawing schematically depicts viewpoints 42a, 42b, and 42c toward a three-dimensional virtual space 40. In a case where an image is displayed on the head-mounted display 100, the viewpoint and the view field can change in accordance with motion of the user head. The drawing indicates that, from time t1 to time t2 and then time t3, the viewpoint changes from the viewpoint 42a to the viewpoint 42b and then the viewpoint 42c and the corresponding view field changes from a view field 44a to a view field 44b and then a view field 44c. Further, it is assumed that the hand object is moving in a direction of an arrow A in the three-dimensional space.

It is assumed that, in the virtual space 40, a hand object 46a whose position, posture, and shape are the same is represented at time t1 and time t2 and that a hand object 46b having the updated posture and shape in the updated position is represented at the following time t3, as depicted in FIG. 6. As the time changes in the order of time t1, time t2, and time t3, a surrounding figure including a background in the virtual space 40 is updated at the same rate. Meanwhile, since the state of the hand object 46a remains unchanged at time t1 and time t2, the hand object 46a appears to be not moving in the arrow A direction. Not only that, the hand object 46a may appear to be moving in the opposite direction due to motion of the background.

Therefore, when the hand object 46b suddenly moves at time t3, a problem that the hand objects 46a and 46b are visually doubly recognized due to the persistence of vision at time t2 may come about. The present inventor acquired the specific knowledge that, in a head-mounted display whose view field can freely change, a difference between the frequency of updating the state information and the frame rate of display images may cause a phenomenon that a figure of an object looks blurry. Also in a device other than a head-mounted display, in a case where a particular object has a display updating frequency different from those of the others, a user sometimes feels a sense of strangeness. In view of this, by predicting the state information, the state information control section 78 adapts the frequency of updating the state of the object to the frame rate of display images.

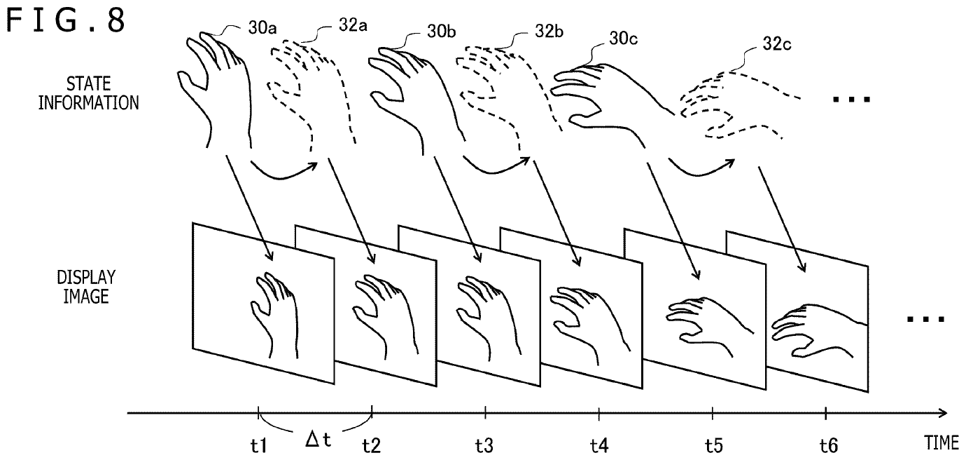

FIG. 8 schematically depicts change in the display image in a case where the state information control section 78 predicts the state information. The manner depicting the drawing and the frequency at which the state information acquisition section 76 acquires the state information from captured images are the same as those in FIG. 6. First, a display image at time t1 is generated in accordance with the state information (state 30a) acquired immediately before time t1 from a captured image. At next time t2, since the state information based on the captured image is not updated, the state information control section 78 predicts the state information (state 32a) in accordance with an elapsed time in a display image generation cycle Δt=t2−t1.

By way of example, the state information control section 78 extrapolates the state information (state 32a) obtained after the elapse of the time Δt from the most recently acquired state information (state 30a), on the basis of the previous change in the state information, that is, the previous change in the position, posture, and shape. The three-dimensional space control section 82 sets the three-dimensional model of the object by using the predicted state information (state 32a), and the display image generation section 84 performs image rendering. Accordingly, the display image at time t2 is generated. It is to be noted that the state information obtained by the prediction is indicated by broken lines.

At next time t3, state information is acquired from a captured image, so that a display image is generated in accordance with the state information (state 30b). At next time t4, the state information control section 78 predicts state information (state 32b) in accordance with an elapsed time in the display image generating cycle Δt because the state information based on the captured image is not updated. The three-dimensional space control section 82 sets a three-dimensional model of the object in accordance with the predicted state information (state 32b), and the display image generation section 84 performs image rendering. Accordingly, the display image at time t4 is generated. At next time t5, a display image is generated in accordance with state information (state 30c) acquired from a captured image. At next time t6, a display image is generated in accordance with predicted state information (state 32c).

According to the above-described procedures, the object state updating frequency can be adapted to the frame rate of display images, and thus, such a problem as blurring of the object can be avoided. However, the state information based on a captured image may include an error and noise caused by various factors including the surrounding brightness and a reflected state of a real hand. These error and noise occur in the course of various kinds of image processing and thus are difficult to control compared to those in a controller that can acquire state information on the basis of a motion sensor or the like. When state information is further predicted from the state information including such an error and noise, the error and noise are magnified. This can result in occurrence of fluctuation (jitter) in the object figure in many cases.

In view of the above circumstances, the state information control section 78 of the present embodiment switches whether or not to predict the state information according to the speed of the real hand, as explained above. During a period of time in which the hand is moving at a speed equal to or greater than a threshold, even if jitter of the figure is generated due to an error in the state information, the jitter is less likely to be recognized as a perceptual characteristic. Therefore, the state information control section 78 activates a state information prediction function such that blurring of the object such as the one explained with reference to FIG. 7 is not visually recognized.

During a period of time in which the speed is less than the threshold at which the hand is considered to be at rest, visible blurring of the object such as the one explained with reference to FIG. 7 does not occur. Therefore, the state information control section 78 does not activate the state information prediction function. Accordingly, jitter of the figure caused by an error and noise is reduced. As a result of this switching of the prediction function, a figure of the hand object can be expressed with high quality irrespective of motion of a hand or change in a view field.

According to this principle, the magnitude of jitter becomes more remarkable as an error and noise in the state information are larger. Therefore, the state information control section 78 may evaluate the accuracy of the state information acquired by the state information acquisition section 76, and may refrain from activating the state information prediction function irrespective of the speed of the hand if a condition for determining that the accuracy is low is satisfied. Whether the prediction function is activated or not in a case where the accuracy of the state information is taken into consideration will be summarized as follows.

TABLE 1

Accuracy of State Information

| | | Low | High |
|---|---|---|---|
| Motion of | Absent | Prediction | Prediction |
| Hand | | OFF | OFF |
| | Present | Prediction | Prediction |
| | | OFF | ON |

Regarding motion of the hand, “Absent” means that the speed is less than a threshold, and “Present” means that the speed is equal to or greater than a threshold. Here, the speed threshold for determining “Present” from “Absent” may be identical to or may be different from the speed threshold for determining “Absent” from “Present.” Hysteresis control of switching whether or not to perform the activation is performed with the different thresholds set, whereby generation of jitter in which switching is repeated within a short period of time can be suppressed. The state information control section 78 acquires the speed of the hand on the basis of the rate of change of the state information acquired so far. The state information control section 78 may make a determination on the entire hand by using the thresholds for the speed, or may make a determination on a part of the hand such as a finger by using the thresholds for the speed.

The state information control section 78 may detect that the hand is about to come to rest, and deactivate the state information prediction function at this timing. By way of example, in a case where the user makes a gesture of putting fingertips together, the speed of the fingers that are moving suddenly becomes 0 at a time point when the fingers come into contact with each other. Therefore, the state information control section 78 may detect that the speed will become 0 within a very short period of time, on the basis of prediction of occurrence of the gesture, and deactivate the state information prediction function at the time point of the detection. Accordingly, prediction that the motion will continue even after the contact between the fingers can be prevented, whereby overshoot of the fingertips of the object can be prevented.

Besides the fingertips put together, the state information control section 78 may detect that the hand object is about to come into contact with another object such as a wall and deactivate the state information prediction function at this time point. Also in this case, overshoot of a fingertip of the object can be prevented.

As a condition for determining that the accuracy of the state information is low, at least any one of a to g below, for example, is introduced.
a. When the speed of the entire hand or a part of the hand exceeds an allowable range in which the accuracy of the state information can be maintained
b. When a hand that is not the target whose state information is to be acquired (the other hand of the user or a hand of another person) is included in a captured image
c. When at least part of the hand that is the target whose state information is to be acquired is hidden by another object
d. When at least part of the hand that is the target whose state information is to be acquired is outside the view field of the camera 110
e. When an average brightness value of a captured image is below an allowable range in which the accuracy can be maintained
f. When the distance from the camera 110 to the hand is below an allowable range in which the accuracy can be maintained
g. When the state information acquisition section 76 detects that the state information acquisition accuracy is low in the middle of processing

In a case where the condition a, e, or f is adopted, a threshold for the “allowable range” is defined in advance. In a case where the condition b, c, d, or g is adopted, in what situation the accuracy of the state information is considered to be low is defined in advance. In a case where two or more of the conditions are adopted, a rule for giving a score to each situation may be defined in advance, and the state information control section 78 may determine that the accuracy of the state information is low by, for example, comparing the total of score values given to the respective situations with a threshold.

In a case where the state information acquisition section 76 has failed to acquire the state information, the state information control section 78 may use the most recently acquired state information to determine the latest state information during a predetermined period of time from the detection of the failure. As a result, if acquisition of normal state information becomes possible within the predetermined period of time, displaying the hand object can be continued with a minor error. Also in this case, the state information control section 78 may determine whether or not to activate the state information prediction function, in accordance with the presence/absence of motion of the hand, for example. A failure in acquiring the state information may be reported by the state information acquisition section 76 to the state information control section 78, or the state information control section 78 may detect such a failure by detecting an abnormal value in the state information.

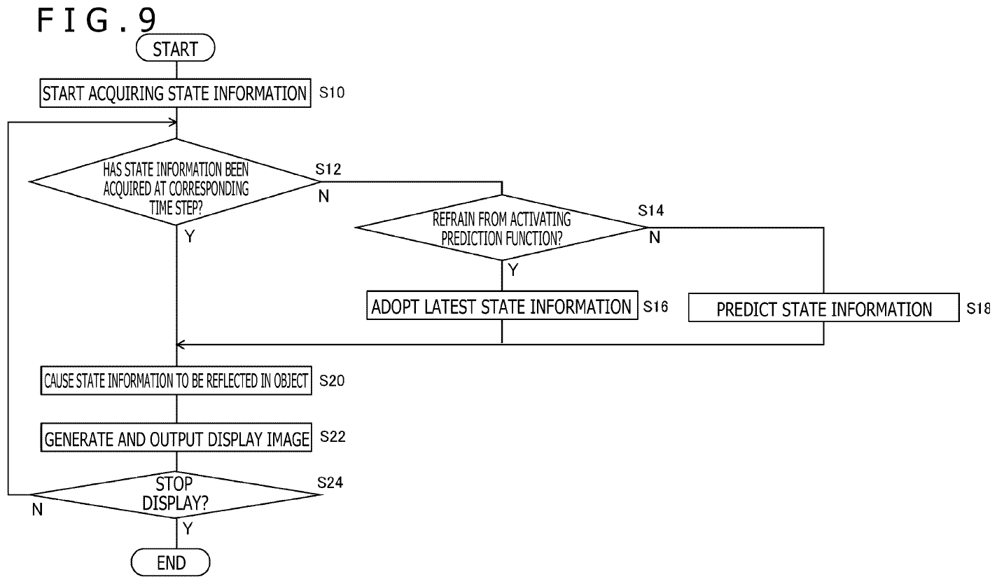

Next, operation of the content processing device 200 that can be realized in the present embodiment will be explained. FIG. 9 is a flowchart of process steps in which the content processing device 200 generates and outputs a display image that includes the hand object reflecting motion of the user hand.

This flowchart is started in a state where the content processing device 200 having established communication with the head-mounted display 100 mounted on the user is acquiring, from the head-mounted display 100, frame data regarding a captured image, user operation details, and data concerning the position and posture of the user head.

First, the state information acquisition section 76 of the content processing device 200 starts acquiring state information regarding the user hand in accordance with a captured image frame (S10). If the state information corresponding to a time step of a display image to be generated at this time point has been acquired directly using the captured image (Y in S12), the state information control section 78 adopts this state information, and the three-dimensional space control section 82 causes this state information to be reflected in the hand object (S20).

If the state information corresponding to a time step of a display image to be generated at this time point has not been acquired directly using the captured image (N in S12), the state information control section 78 determines whether or not to activate the state information prediction function (S14). Specifically, the state information control section 78 determines whether or not to activate the prediction function, in accordance with the speed of the hand based on the state information acquired so far and the accuracy of acquiring the state information and according to the condition settings in the above table or the like. It is to be noted that the state information control section 78 may determine whether or not to activate the prediction function, in accordance with either the speed of the hand or the accuracy of acquiring the state information.

When determining to refrain from activating the prediction function (Y in S14), the state information control section 78 adopts the most recently acquired state information having been acquired using the captured image (S16). When determining to activate the prediction function (N in S14), the state information control section 78 uses the state information acquired so far, to predict state information corresponding to a time step of a display image to be generated (S18). The state information to be used for the prediction may be limited to those directly acquired from captured images, or may include the state information predicted previously.

In either case, the three-dimensional space control section 82 causes the state information determined in S16 or S18 to be reflected in the hand object (S20). Concurrently with this, the three-dimensional space control section 82 may cause a result of information processing to be reflected in objects in the three-dimensional space according to a request from the information processing section 74. The display image generation section 84 generates frame data of a display image by rendering the objects of the latest state in the three-dimensional space, and sequentially outputs the frame data to the head-mounted display 100 via the output section 86 (S22).

If stopping the display due to completion of the content or a user operation is not required (N in S24), the content processing device 200 repeats S12 to S22 at a predetermined rate. Accordingly, a video that includes the object reflecting motion of the user hand is displayed on the head-mounted display 100. It is to be noted that the frequency of the determination process in S12 and S14 may be equal to the display frame rate or may be lower than the display frame rate. If stopping the display is required, the content processing device 200 terminates all the processes (Y in S24).

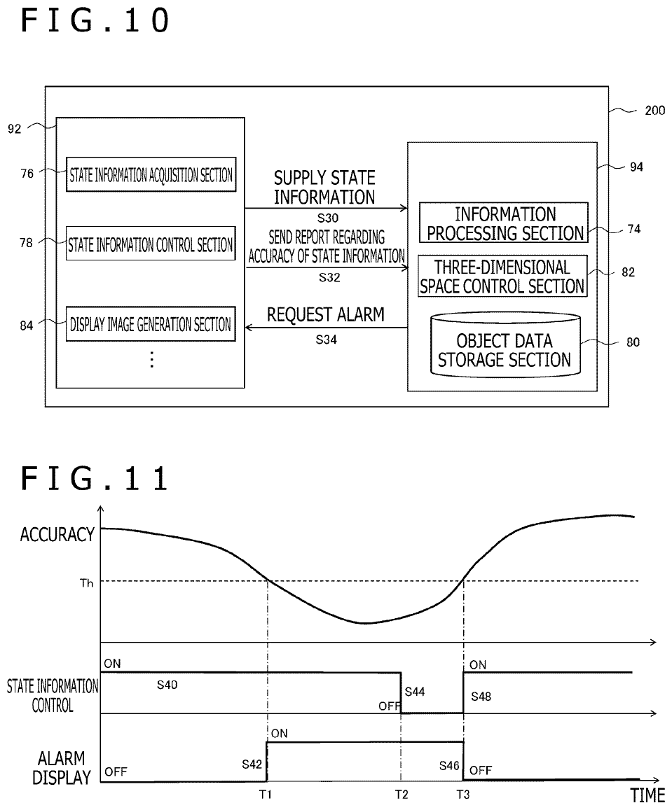

In the present embodiment, data regarding the accuracy of acquired state information can be used not only for determining whether or not to activate the state information prediction function but also for part of the content processing. FIG. 10 is a diagram for explaining a manner in which an evaluation result of the accuracy of state information is used for content processing. FIG. 10 depicts that the content processing device 200 includes a system section 92 that functions in common in any kind of applications and an application section 94 that processes a program of an application.

The system section 92 includes the captured-image acquisition section 70, the operation information acquisition section 72, the state information acquisition section 76, the state information control section 78, the display image generation section 84, and the output section 86 which are depicted in FIG. 4, although some of them are omitted in FIG. 10. The application section 94 includes the information processing section 74, the three-dimensional space control section 82, and the object data storage section 80. However, the allocation depicted in the drawing is merely one example.

As explained above, the state information control section 78 determines the latest state information in accordance with the state information regarding the user hand directly acquired from a captured image by the state information acquisition section 76, as depicted in FIG. 9. The latest state information is supplied to the application section 94 (S30), so that the three-dimensional space control section 82 causes the state information to be reflected in the hand object in the three-dimensional space. Further, the information processing section 74 of the application section 94 processes an application program such as an electronic game, and the three-dimensional space control section 82 causes a result of the process to be reflected in the three-dimensional space.

If the accuracy of the state information acquired by the state information acquisition section 76 is deteriorated during this process, the state information control section 78 sends a report regarding this situation to the application section 94 (S32). Here, the accuracy deteriorations of the state information include a failure in acquisition of the state information and detection of an abnormal value in the state information. In addition, the state information acquisition section 76 may detect, as an accuracy deterioration, that any one of the above conditions a to g is satisfied. In any case, the state information control section 78 may additionally report a basis for the determination of the accuracy deterioration to the application section 94. Even if the accuracy of the state information is deteriorated, the state information control section 78 may determine the latest state information by using the most recently acquired state information and continuously report the determined state information to the application section 94 for a predetermined period of time.

Various types of processes can be performed by the information processing section 74 of the application section 94 in response to the report regarding the accuracy deterioration of the state information. By way of example, in a case where the accuracy deterioration is caused because the distance from the hand to the camera 110 is below the allowable range in which the accuracy can be maintained, the information processing section 74 may request that the display image generation section 84 of the system section 92 provide, to the user, an alarm indicating that the distance to the hand is excessively short (S34). In a case where the hand is partially hidden or a case where another hand is included in a captured image, the information processing section 74 also may request for an alarm to the user. It is to be noted that a change requested to be imparted to a display image by the application section 94 is not limited to the alarm to the user, and may be concealing an object, for example.

In addition, the information processing section 74 may determine whether or not to cause the state information determined by the state information control section 78 to be reflected in the object, in accordance with a criterion specified in the application. The hand object may be fixed without using the state information that is supplied when the accuracy is low, or an option of causing the state information to be reflected in the hand object even if the accuracy is low may be given to the application side. Accordingly, motion of the hand object can be adapted to a circumstance specific to the content or the world design of the content.

When the accuracy of the state information is recovered, the state information control section 78 sends a report regarding the recovery to the application section 94 (S32). It is to be noted that a report regarding deterioration or recovery of the accuracy of the state information may be made by updating a flag stored in a memory that both the system section 92 and the application section 94 can access. In addition, the system section 92 may sequentially report data regarding the accuracy of the state information itself to the application section 94. In this case, the application section 94 may alter the information processing and alter a request to the system section 92 according to the level of the accuracy. Accordingly, it is possible to more finely address change in the accuracy.

FIG. 11 illustrates representative process timings with respect to change in the accuracy of the state information. In the drawing, the top line indicates time change in the accuracy of the state information, the middle line indicates ON/OFF of normal control of the state information, and the bottom line indicates ON/OFF of alarm display to the user with the time axis in the horizontal direction. It is to be noted that the “accuracy” of the state information is an evaluation value of the accuracy in a strict sense. A specific value thereof varies depending on a basis for evaluating the accuracy. Thus, the evaluation value is not limited to a value that represents a continuous change as depicted in the drawing, and may be a value that represents discontinuous binary change.

First, during a period of time in which the accuracy of the state information is equal to or greater than a threshold Th, the state information control section 78 controls the state information in a normal manner in accordance with the chart depicted in FIG. 9, and supplies a result of the control to the application section 94 (S40). It is to be noted that a threshold of the accuracy of the state information for determining whether or not to activate the prediction function in the chart may be identical to the threshold Th in FIG. 11 or may be greater than the threshold Th.

If the accuracy of the state information falls below the threshold Th at time T1, the state information control section 78 reports the accuracy deterioration of the state information to the application section 94. If an alarm request is given from the application section 94 in response, the display image generation section 84 starts displaying an alarm (S42). Meanwhile, the state information control section 78 continues the normal control of the state information and continuously supplies the result of the control to the application section 94 (S40) while the accuracy of the state information is below the threshold Th. At time T2 when a predetermined period of time has elapsed from the time when the state where the accuracy of the state information is below the threshold Th is established, the state information control section 78 determines that acquisition of the state information has failed, and temporarily halts the normal control of the state information (S44).

When the accuracy of the state information becomes equal to or greater than the threshold Th at time T3, the state information control section 78 reports recovery of the accuracy of the state information to the application section 94. Then, the display image generation section 84 stops the alarm display (S46). It is to be noted that a threshold for starting the alarm display and a threshold for stopping the display may be the same, as depicted in the drawing, or may be different from each other. In addition, stopping the alarm display may be performed in response to a request from the application section 94, or may be determined by the display image generation section 84 itself.

Further, at time T3, the state information control section 78 resumes the normal control of the state information (S48). According to the time control depicted in the drawing, even if the accuracy of the state information is deteriorated, a possibility of recovering the accuracy within a short period of time can be increased while a process amount in the application section 94 is minimized and the state of the object is maintained as properly as possible.

According to the above-described present embodiment, in a mode in which motion of a target in the real world is reflected in a displayed object, the latest state information is predicted in accordance with state information acquired so far. Accordingly, even if the frequency of acquiring the state information from a captured image is set to be lower than the display frame rate, the frequency of updating the state of the object can be adapted to the frame rate. As a result, the frequency of updating a figure of the object reflecting the motion and the frequency of updating the remaining figures become equal to each other, whereby a failure such as figure blurring can be avoided.

Meanwhile, an error and noise may be magnified due to the prediction, and jitter of the object figure may be generated. In view of this problem, the prediction function is deactivated according to circumstances including the speed of the target or the acquisition accuracy of the state information. As a result, in synergy with an effect of ensuring time for acquiring the state information, displaying an image that includes an object reflecting motion of a target can be continued with high quality regardless of the situation.

In addition, information regarding the accuracy of the state information is provided to a subject processing the content application. Accordingly, even if the accuracy of the state information is deteriorated, an optimal countermeasure can be taken according to the content. For example, whether or not to use the state information the accuracy of which has been deteriorated is determined, or an option of providing an alarm to the user to eliminate the factor of the accuracy deterioration is provided, whereby various countermeasures can be taken according to a desired accuracy and desired world design of the content. Accordingly, the quality of the object reflecting motion of the target can preferably be maintained.

The present disclosure has been explained so far on the basis of the embodiments. The embodiments exemplify the present disclosure, and a person skilled in the art will understand that various modifications can be made to a combination of the constituent elements or the process steps of the embodiments and that these modifications are also within the scope of the present disclosure.

The present disclosure may include the following modes.

### [Item 1]

A display image generation device including:
a circuitry configured to
   acquire state information regarding a target in accordance with a figure of the target in an image obtained by video capturing by an imaging device,
   determine state information to be adopted, by switching whether or not to manipulate the state information in accordance with an elapsed time according to a situation, and
   use the determined state information to generate a display image that includes a virtual object reflecting motion of the target.

### [Item 2]

The display image generation device according to item 1, in which,
when a predetermined condition for considering that the target is moving is satisfied, the circuitry manipulates the state information in accordance with an elapsed time.

### [Item 3]

The display image generation device according to item 1, in which,
when a predetermined condition for considering that an accuracy of the state information acquired by the state information acquisition section is low is satisfied, the circuitry refrains from manipulating the state information in accordance with an elapsed time.

### [Item 4]

The display image generation device according to item 3, in which
the circuitry determines, as the condition for determining that the accuracy is low, that at least any one of a speed of the target, an average brightness value of the captured image, and a distance from the target to the imaging device is outside a predetermined allowable range.

### [Item 5]

The display image generation device according to item 3, in which,
by evaluating at least any one of how much an object of the same type as the target is included in the captured image, how much the target is hidden, and how much the target is outside a view field of the imaging device, the circuitry determines whether or not the condition for determining that the accuracy is low is satisfied.

### [Item 6]

The display image generation device according to item 1, in which,
for a predetermined period of time from detection of a failure of acquisition of the state information based on the figure of the target, the circuitry uses the most recently acquired state information and continues determining the state information to be adopted.

### [Item 7]

The display image generation device according to item 1, in which
the circuitry further processes a content application in which the display image is defined,
the circuitry supplies information regarding an accuracy of the state information based on the figure of the target to the application, and
the circuitry imparts a change to the display image according to a request corresponding to the information regarding the accuracy from the application.

### [Item 8]

The display image generation device according to item 7, in which,
when a predetermined condition for considering that the accuracy of the state information is deteriorated is satisfied, the circuitry sends a report regarding the deterioration to the application, and
the circuitry displays an alarm to a user according to a request corresponding to the accuracy deterioration from the application.

### [Item 9]

A content processing system including:
the display image generation device according to item 1; and
a head-mounted display that acquires data regarding the display image from the display image generation device and displays the display image.

### [Item 10]

A display image generation method including:
acquiring state information regarding a target in accordance with a figure of the target in an image obtained by video capturing by an imaging device;
determining state information to be adopted, by switching whether or not to manipulate the state information in accordance with an elapsed time according to a situation; and
using the determined state information to generate a display image that includes a virtual object reflecting motion of the target.

### [Item 11]

A recording medium having a program recorded therein for a computer to implement:
a function of acquiring state information regarding a target in accordance with a figure of the target in an image obtained by video capturing by an imaging device;
a function of determining state information to be adopted, by switching whether or not to manipulate the state information in accordance with an elapsed time according to a situation; and
a function of using the determined state information to generate a display image that includes a virtual object reflecting motion of the target.

What is claimed is:

1. A display image generation device comprising:
a state information acquisition section that acquires state information regarding a target in accordance with a figure of the target in an image obtained by video capturing by an imaging device;
a state information control section that determines state information to be adopted, by switching whether or not to manipulate the state information in accordance with an elapsed time according to a situation; and
a display image generation section that uses the determined state information to generate a display image that includes a virtual object reflecting motion of the target.

2. The display image generation device according to claim 1, wherein,
when a predetermined condition for considering that the target is moving is satisfied, the state information control section manipulates the state information in accordance with an elapsed time.

3. The display image generation device according to claim 1, wherein,
when a predetermined condition for considering that an accuracy of the state information acquired by the state information acquisition section is low is satisfied, the state information control section refrains from manipulating the state information in accordance with an elapsed time.

4. The display image generation device according to claim 3, wherein
the state information control section determines, as the condition for determining that the accuracy is low, that at least any one of a speed of the target, an average brightness value of the captured image, and a distance from the target to the imaging device is outside a predetermined allowable range.

5. The display image generation device according to claim 3, wherein,
by evaluating at least any one of how much an object of a same type as the target is included in the captured image, how much the target is hidden, and how much the target is outside a view field of the imaging device, the state information control section determines whether or not the condition for determining that the accuracy is low is satisfied.

6. The display image generation device according to claim 1, wherein,
for a predetermined period of time from detection of a failure of acquisition, by the state information acquisition section, of the state information, the state information control section uses the most recently acquired state information and continues determining the state information to be adopted.

7. The display image generation device according to claim 1, further comprising:
an information processing section that processes a content application in which the display image is defined, wherein
the state information control section supplies information regarding an accuracy of the state information acquired by the state information acquisition section to the information processing section, and
the display image generation section imparts a change to the display image according to a request corresponding to the information regarding the accuracy from the information processing section.

8. The display image generation device according to claim 7, wherein,
when a predetermined condition for considering that the accuracy of the state information is deteriorated is satisfied, the state information control section sends a report regarding the deterioration to the information processing section, and
the display image generation section displays an alarm to a user according to a request corresponding to the accuracy deterioration from the information processing section.

9. A content processing system comprising:
a display image generation device including
a state information acquisition section that acquires state information regarding a target in accordance with a figure of the target in an image obtained by video capturing by an imaging device,
a state information control section that determines state information to be adopted, by switching whether or not to manipulate the state information in accordance with an elapsed time according to a situation, and
a display image generation section that uses the determined state information to generate a display image that includes a virtual object reflecting motion of the target; and
a head-mounted display that acquires data regarding the display image from the display image generation device and displays the display image.

10. A display image generation method comprising:
acquiring state information regarding a target in accordance with a figure of the target in an image obtained by video capturing by an imaging device;
determining state information to be adopted, by switching whether or not to manipulate the state information in accordance with an elapsed time according to a situation; and
using the determined state information to generate a display image that includes a virtual object reflecting motion of the target.

11. A computer program for a computer, comprising:
by a state information acquisition section, acquiring state information regarding a target in accordance with a figure of the target in an image obtained by video capturing by an imaging device;
by a state information control section, determining state information to be adopted, by switching whether or not to manipulate the state information in accordance with an elapsed time according to a situation; and
by a display image generation section, using the determined state information to generate a display image that includes a virtual object reflecting motion of the target.
